(19) United States
(12) Patent Application Publication
(10) Pub. No.: US 2013/0173742 A1
(43) Pub. Date: Jul. 4, 2013

(54) SYSTEMS AND METHODS FOR LATENCY-BASED SYNCHRONIZED PLAYBACK AT MULTIPLE LOCATIONS

(71) Applicants: William L. Thomas, Malvern, PA (US); Eric W. Grab, San Diego, CA (US); Walter R. Klappert, Los Angeles, CA (US); Thomas S. Woods, Arlington Heights, IL (US); Michael R. Nichols, La Canada-Flintridge, CA (US)

(72) Inventors: William L. Thomas, Malvern, PA (US); Eric W. Grab, San Diego, CA (US); Walter R. Klappert, Los Angeles, CA (US); Thomas S. Woods, Arlington Heights, IL (US); Michael R. Nichols, La Canada-Flintridge, CA (US)

(73) Assignee: UNITED VIDEO PROPERTIES, INC., Santa Clara, CA (US)

(21) Appl. No.: 13/338,536

(22) Filed: Dec. 28, 2011

(51) Int. Cl. G06F 15/16

(52) U.S. Cl. 709/217

(57) ABSTRACT

Embodiments provide methods and systems for synchronizing simultaneous media asset viewing for users at different geographical viewing locations. In some embodiments, a first user device receives a request to synchronize viewing of a media asset with a second user device. If the first user device accepts the request for synchronized viewing, the first and second user devices receive the media asset from a common source. Control circuitry at the common source may determine the latencies to the first and second user devices. The transmission of the media asset to the first and second user devices is adjusted according to the latencies.

### BACKGROUND

With conventional media guidance applications, if viewers in different locations want to watch a program at the same time, certain complications and uncertainties can arise. For example, a viewer in one location may receive the program slightly before a viewer in a different location due to different latencies between the media source and the respective locations of the viewers. If the viewers are communicating with each other while watching the program, one user would then see events before the other user, making the experience less enjoyable for both viewers than if the viewing were better aligned. For example, if the program is a drama or sports event, the first viewer may see a plot twist or major play before the second viewer. If the program is a game show, the first viewer may have seen trivia questions or puzzles before the second viewer, giving the first user an advantage if the viewers are playing along.

### SUMMARY OF THE INVENTION

Accordingly, methods and systems are described herein for synchronizing simultaneous media asset viewing for users at different geographical viewing locations. In some embodiments, a first user device receives a request to synchronize viewing of a media asset with a second user device. If the first user device accepts the request for synchronized viewing, the first and second user devices receive the media asset from a common source. Control circuitry at the common source may determine the latencies to the first and second user devices. The transmission of the media asset to the first and second user devices is adjusted according to the latencies. By adjusting the transmission of the media asset according to the latencies, the user devices play segments of the program simultaneously, so that one user does not see important events (e.g., a scoring play in a sports event, or the answer to a puzzle) before another user.

In some embodiments, a user device receives from a user of the user device a request to synchronize the viewing of a particular program with a second user device. The user device may send an invitation to participate in synchronized viewing to a second user device, which a user of the second user device may either accept or decline. If the user of the second user device accepts the invitation, the transmission of the media asset to the first and second user devices may begin immediately, after a predetermined time period, or after one or more additional invited user devices have responded to a similar invitation.

In some embodiments, the media source determines the time that it takes a user device to process or decode the media asset so that it can be displayed (i.e., the decoding latency). The latency between the media source may be the sum of the decoding latency and the transmission latency.

In some embodiments, the media source is a user device that has access to a stored version of the media asset. The media source may have recorded the media asset when it aired. The media source may participate in the synchronized viewing with at least one other user device in another location.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows and illustrative display screen that may be used to provide media guidance application listings and other media guidance information in accordance with an embodiment of the invention;

FIG. 2 shows another illustrative display screen that may be used to provide media guidance application listings in accordance with an embodiment of the invention;

FIG. 3 is a block diagram of an illustrative user equipment device in accordance with an embodiment of the invention;

FIG. 4 is a block diagram of an illustrative interactive media system in accordance with an embodiment of the invention;

FIG. 5 is an illustrative display screen for displaying an option to set up synchronized viewing for a program in accordance with an embodiment of the invention;

FIG. 6 is an illustrative display screen for displaying selectable synchronization set up elements in accordance with an embodiment of the invention;

FIG. 7 is an illustrative display screen showing a selectable list of buddies and groups for synchronized viewing in accordance with an embodiment of the invention;

FIG. 8 is an illustrative display screen showing selectable synchronization setup options in accordance with an embodiment of the invention;

FIG. 9 is an illustrative display screen showing a synchronization summary for a program scheduled for synchronized viewing in accordance with an embodiment of the invention;

FIG. 10A is an illustrative display screen showing a synchronization invitation in accordance with an embodiment of the invention;

FIG. 10B is an illustrative display screen showing a second synchronization invitation in accordance with another embodiment of the invention;

FIG. 11 is an illustrative display screen showing buddy setup features for modifying buddy lists for use in synchronized viewing in accordance with an embodiment of the invention;

FIG. 12 is an illustrative display screen showing a warning overlay screen in accordance with an embodiment of the invention;

FIG. 13 is an illustrative display screen showing synchronized program display with a warning indicator in accordance with an embodiment of the invention;

FIG. 14 is an illustrative display screen showing synchronized program display with a chat feature in accordance with an embodiment of the invention;

FIG. 15 is an illustrative display screen showing synchronized program display with a video chat feature in accordance with an embodiment of the invention;

FIG. 16 shows an illustrative process for setting up and engaging in synchronized viewing in accordance with an embodiment of the invention;

FIG. 17A shows an illustrative process for using a synchronization master to synchronize viewing on multiple devices in accordance with an embodiment of the invention;

FIG. 17B shows an illustrative process for using a synchronization master to transmit a program to at least one other device for synchronized viewing in accordance with an embodiment of the invention;

FIG. 18 shows an illustrative process for receiving and responding to a synchronization invitation in accordance with an embodiment of the invention;

FIG. 19 shows an illustrative process for addressing a situation in which a device scheduled for synchronized viewing of a program has viewed the program ahead of schedule in accordance with an embodiment of the invention; and

FIG. 20 shows an illustrative process for addressing a situation in which a device scheduled for synchronized viewing of a program has viewed a part of the program ahead of schedule in accordance with an embodiment of the invention.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. The various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

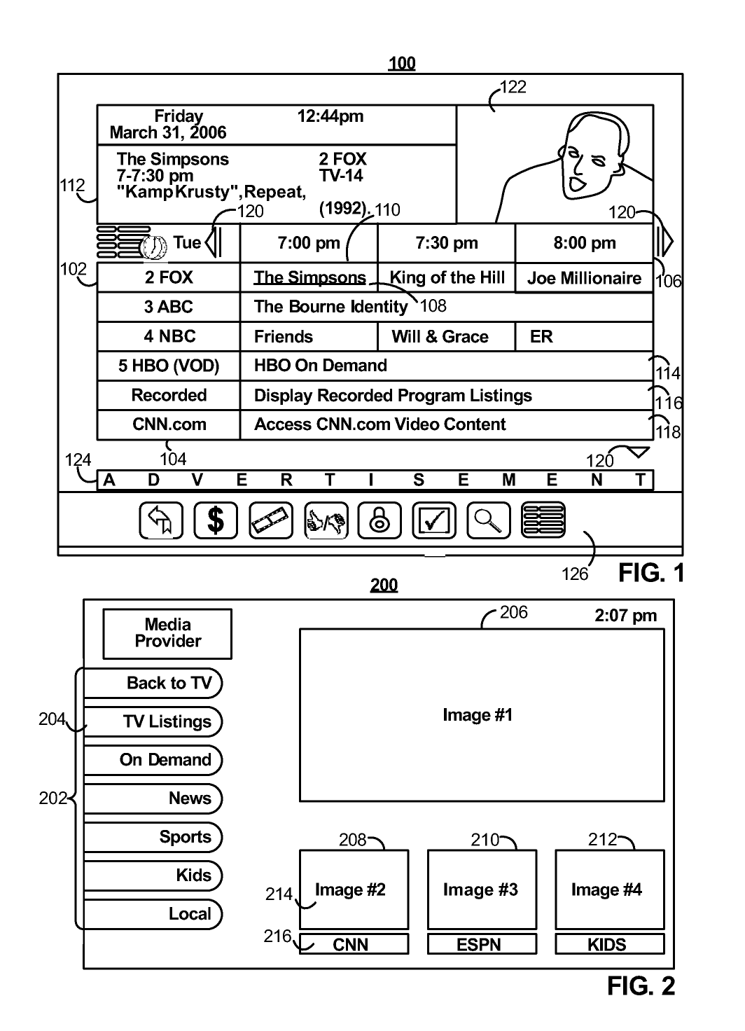

FIGS. 1-2 show illustrative display screens that may be used to provide media guidance data. The display screens shown in FIGS. 1-2 and 5-15 may be implemented on any suitable user equipment device or platform. While the displays of FIGS. 1-2 and 5-15 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options. Another selectable option in the options region 126 may relate to setting up synchronized viewing with a viewer at a different location.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005; Boyer et al., U.S. Pat. No. 7,165,098, issued Jan. 16, 2007; and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

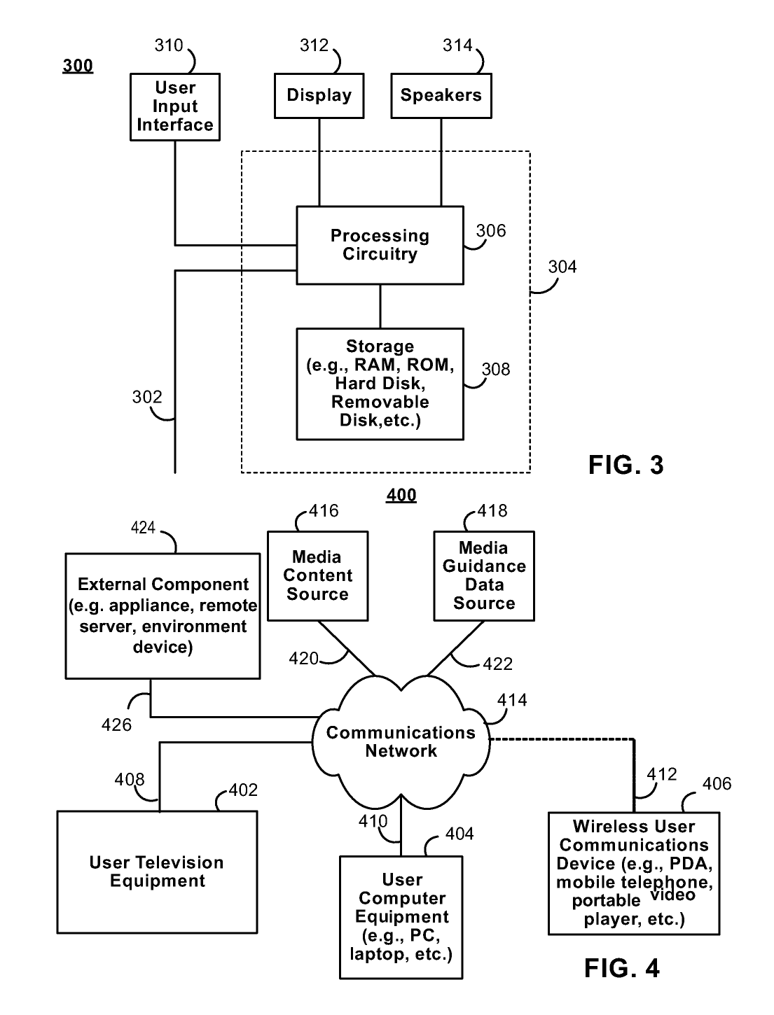

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). In some embodiments, control circuitry 304 may receive user input for scheduling synchronized viewing of a program with other user equipment. Control circuitry 304 may automatically generate an invitation to send to other user equipment. In particular, the invitation may instruct control circuitry 304 on the other user equipment device to display the invitation to a user with display 312 and receive a response to the invitation at the other user equipment device, which is sent back to the sending user equipment. Control circuitry 304 may determine whether it or other user equipment device should record the program when it becomes available. In some cases, control circuitry 304 may instruct tuning and encoding circuitry to record a program for synchronized viewing. Control circuitry 304 may coordinate synchronized of a program viewing with other user equipment. In some embodiments, the synchronization is based on latencies between user equipment devices and/or one or more servers. A latency between a user equipment device and a server is determined, and the transmission of the program to the user equipment device may be adjusted based on the latency. In some embodiments, the display of the program at the user equipment device is based on the determined latency. These and other aspects of control circuitry 304 are described in further detail below.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below). In particular, the communications circuitry may be suitable for communicating over a network with other user equipment devices, either directly or through a central server, to schedule simultaneous viewing of programs and synchronize the display of programs for simultaneous viewing.

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach).

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418). running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications or the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

As discussed herein, an application running on user equipment may be used for scheduling synchronized viewing, communicating information related to the synchronized viewing to another interactive media guidance application on a user equipment device in another geographic location, and simultaneously synchronizing display of the program with the interactive media guidance application in the other geographic location. These functions are described herein as being performed by or in relation to an interactive media guidance application; however, in other embodiments, any other application running on user equipment can be used to carry out the methods described herein. As used herein, a program refers to a media asset which can be accessed via a video feed, an audio feed, a video file, or an audio file. As used herein, synchronized viewing refers to a process wherein a program is displayed or otherwise presented to a first viewer on a first user equipment device while the same program or a similar program (e.g., the same base program broadcast on a different network with different advertisements) is being displayed or presented to a second viewer by a second user equipment device, such that during a given segment of time, the portion of the program being presented by the first user equipment device is substantially the same as the portion of the program being presented by the second user equipment device. In other words, the first and second user equipment devices simultaneously present the same program. As used herein, “Buddies” refer to other users that may participate in synchronized viewing, and “Groups” refer to collections of two or more other users that may participate in synchronized viewing.

In some embodiments, the program becomes available at some user equipment devices before it becomes available at other user equipment devices. A program becomes available when a user equipment device is able to access the program. For example, a program may become available when it is broadcast, webcast, or made available on-demand to a television, computer, smart phone, or other media access device. A program may be made available when the media access provider receives a payment for a particular program (e.g., a pay-per-view program). A program may be made available when a user receives physical media, such as a CD-ROM, DVD, Blu-ray disc, or USB drive, containing the program.

In general, control circuitry 304 at a first user equipment device receives via user input interface 310 input from a user to schedule synchronized viewing with one or more users of additional user equipment devices. The input may include, for example, the program for simultaneous viewing, the time at which the program becomes available at the first user equipment device and/or additional user equipment device, and an identification of at least one other user to engage in synchronized viewing. Control circuitry 304 communicates via communications network 414 information related to the scheduled synchronized viewing to the user equipment of the at least one other user. Control circuitry 304 determines whether it should cause the first user equipment device to record the program (e.g., if the program airs at the first user equipment device before it airs on another user equipment device) and records the program if needed. Once the program becomes available to all of the user equipment devices, control circuitry 304 of one or more of the user devices and/or a central server coordinate synchronized viewing of the program.

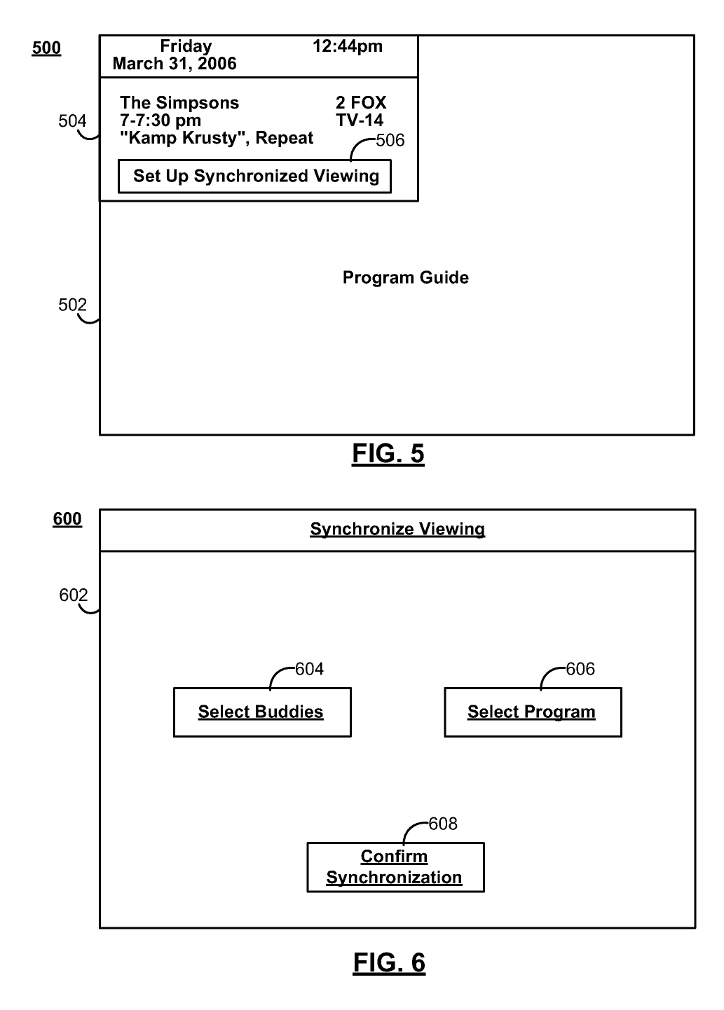

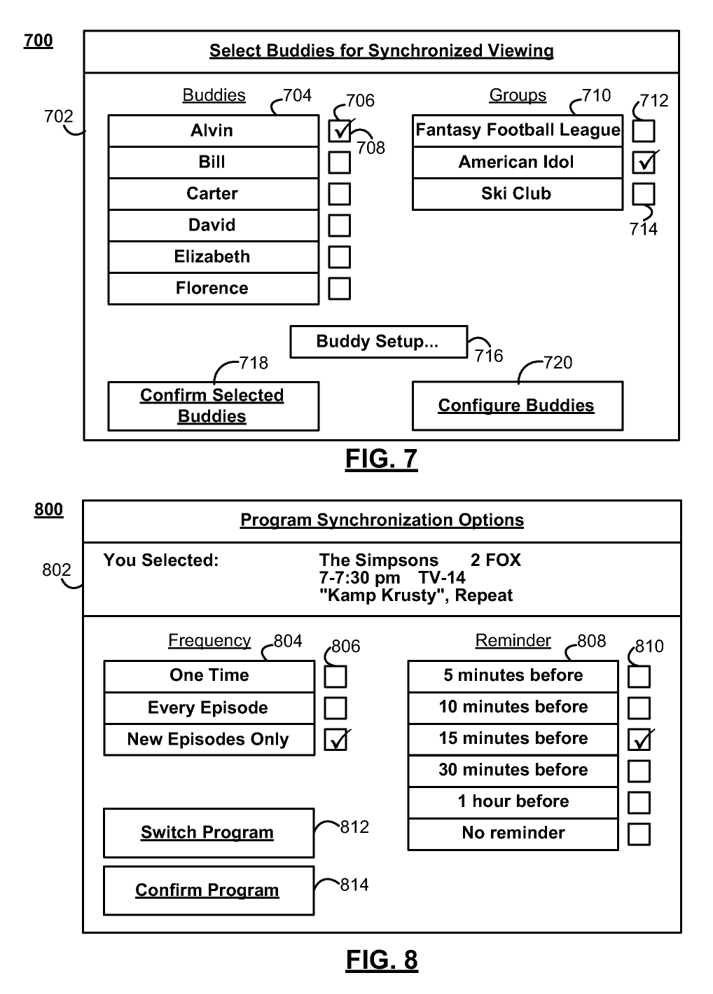

The process of setting up and carrying out synchronized viewing between multiple viewers is illustrated by the display screens shown in FIGS. 5 through 15. The process of setting up synchronized viewing is initiated when control circuitry 304 receives an indication that a user wishes to schedule synchronized viewing. This is illustrated in FIG. 5, which is an illustrative display screen 500 of an interactive media guidance application that shows an option to set up synchronized viewing for a program. As shown in FIG. 1, a user can select a program listing by, for example, moving a highlight region or a cursor in a program guide 502. Information relating to the program listing selected in the program guide 502 may be provided in program information region 504. The program information region 504 may include, for example, the program title, the program description, the time the program becomes available, the channel the program is on, the program's rating, and any other information that may be of interest to the user. The program information region 504 includes a Set Up Synchronized Viewing button 506. Selecting the Set Up Synchronized Viewing button 506 causes control circuitry 304 to instruct the display to present synchronized viewing setup user interfaces, such as those illustrated by the display screens of FIGS. 6-9. In particular, after control circuitry 304 has received a command from a user to set up synchronized viewing for the program shown in the program information region, control circuitry 304 may instruct the display to present an interface that allows a user to select one or more other viewers to invite for synchronized viewing.

In other embodiments, control circuitry 304 may provide access to synchronized viewing setup via the interactive media guidance application without requiring the user to select a program in a program guide. For example, as described in relation to FIG. 1, one of the selectable options in the options region 126 of the interactive media guide application may be an option to set up synchronized viewing. In other embodiments, a user input device may have a particular button or sequence of buttons which, when selected, cause control circuitry 304 to present a synchronized viewing setup user interface, such as the Synchronize Viewing screen shown in FIG. 600.

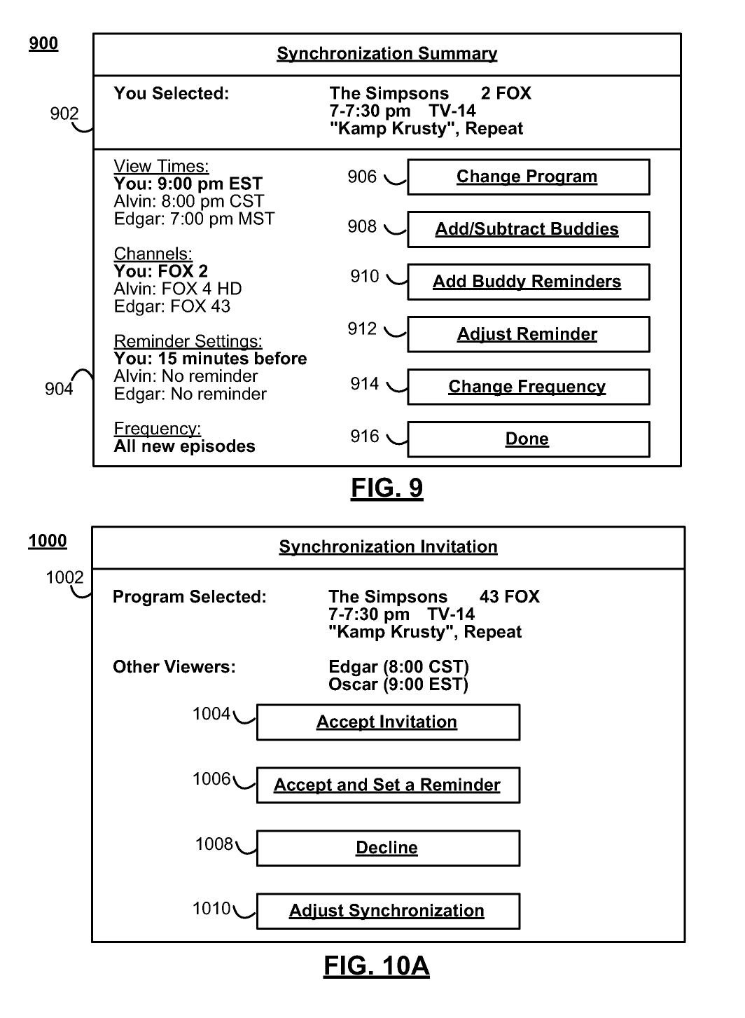

The Synchronize Viewing screen 600 presents selectable synchronization setup elements. As shown, the synchronize menu 602 includes three buttons: a Select Buddies button 604, a Select Program button 606, and a Confirm Synchronization button 608. If the user selects the Select Buddies button 604, control circuitry 304 causes the display to present a user interface on a new screen or an overlay by which control circuitry 304 can receive input from the user indicating buddies or groups of buddies to invite to participate in synchronized viewing. If the user selects the Select Program button 604, control circuitry 304 causes the display to present a user interface on a new screen or an overlay, such as the program grid 102 shown in FIG. 1, by which control circuitry 304 can receive input the user indicating a selected program for synchronized viewing. The synchronization menu 602 may include additional buttons to display additional menus as needed. Once the user has chosen buddies and a program, the user may select the Confirm Synchronization button 608, which causes control circuitry 304 to add the program to its schedule, send the synchronization information to the selected buddies, and in some cases, record the program. In some embodiments, the user may review and confirm the settings through, for example, the Synchronization Summary screen shown in FIG. 9.

If the user selected a program before selecting to set up synchronization, e.g., as shown in FIG. 5, control circuitry 304 may not display the synchronization menu 602, but rather immediately presents a user interface with which the user can select buddies.

A Select Buddies screen 700 for presenting selectable buddies and groups of buddies to invite to participate in synchronized viewing is shown in FIG. 7. A buddy selection menu 702 displays a list of buddies 704 and a list of groups 710. In general, buddies are other users that a user knows personally, such as family member, friends, club or team members, or coworkers. Groups are collections of two or more users. In some embodiments, a group is a list of buddies with which a user wants to watch multiple programs. For example, a fantasy football league may create a fantasy football group to set up synchronized viewing of NFL games. In such a case, it may be easier for the user to select a group of his buddies than select each individual buddy each time the user wants to set up a synchronized viewing. In some embodiments, a user can group his buddies without the buddies receiving notification that they are in a group. In other embodiments, information about a group created by one user is proliferated to the other members of the group, so that each member knows they belong to the group and may be able to invite the group for synchronized viewing. In some embodiments, group members may not be personally known to a user, but may share a common interest and subscribe to a group based on the common interest. For example, a fan of the program “American Idol” may join an American Idol group to participate in synchronized viewing with other fans that the fan may or may not know. In some embodiments, a group may have one or more group masters who can create synchronization invitations as well as group members who can receive and respond to, but not create, synchronization invitations.

Via the buddy selection menu 702, control circuitry 304 receives input from a user indicating one or more available buddies and/or groups to invite for synchronized viewing. For example, the buddy selection menu 702 may include check boxes 706 and 712 next to each buddy and group. Control circuitry 304 may then cause the display to visually indicate that the buddy or group has been selected by, e.g., putting a check 708 or other marking in the box 706 or 712, by highlighting the buddy, by changing the color of the buddy's name or group name, or another visual representation.

The buddy selection menu 702 also includes a Buddy Setup button 716. When the Buddy Setup button 716 is selected, control circuitry 304 instructs the display to present a user interface on a new screen or an overlay. From this Buddy Setup interface, control circuitry 304 can receive instructions to change the buddy list by, for example, adding or removing buddies, changing information related to existing buddies, or adding, removing, or editing groups. An exemplary implementation of a buddy selection menu is shown in FIG. 11. The buddy selection menu 702 also includes a Confirm Selected Buddies button 718. When the Confirm Selected Buddies button 718 is selected, control circuitry 304 stores the selected buddies and causes the display to present a different user interface screen, such as main Synchronize Viewing screen 600, or an interface screen for performing an additional step in synchronization setup, such as a Select Program screen which displays a selectable program guide, or Program Synchronization Options screen, shown in FIG. 8. The buddy selection menu 702 may also include a Configure Buddies button 720, which, when selected, causes control circuitry 304 to instruct the display to present configurable options for the display of the buddies and groups, e.g., the order in which the buddies and groups should be displayed in the interactive media guidance application, whether any buddies or groups should be automatically included for all or particular programs, and how many buddies and/or groups to display on the screen.

In addition to selecting the program and other viewers for synchronized viewing, other options, such as reminders and frequency settings, may be received by control circuitry 304. A Program Synchronization Options screen 800 for presenting such selectable program synchronization setup options is shown in FIG. 8. At the top of the screen, control circuitry 304 instructs the display to present a summary of information 802 of the program selected for synchronized viewing. Below the summary section 802 is a selectable frequency setting which lists several frequencies 804 with which the program can be scheduled for synchronized viewing and a check box selection interface 806 for receiving user input of a frequency. Through the frequency selection interface 806, control circuitry 304 receives input indicating that the program should be scheduled for synchronized viewing a single time only, each time an episode is aired, or only when new episodes are aired. The Program Synchronization Options screen 800 also includes a selectable reminder setting 808 with which control circuitry 304 can receive an instruction to present a reminder to the user that the user is scheduled to engage in synchronized viewing through a check box selection interface 810. The reminder times listed are lengths of time before the synchronized viewing is scheduled to begin. For example, control circuitry 304 can present a reminder 5 minutes, 10 minutes, 15 minutes, 30 minutes, or an hour before synchronized viewing is scheduled. In some embodiments, control circuitry 304 may be configured to instruct a device other than the user equipment with which the synchronized program is presented to display a reminder or otherwise alert the user of the scheduled time for synchronized viewing. For example, if the user watches the program on a television, the reminder may be presented on the user's cell phone.

Once information related to some or all of the program, buddies and/or groups, reminder, and frequency of the program selected for synchronized viewing has been received, control circuitry 304 may seek a user confirmation of the synchronization selections. To allow the user to review the scheduled synchronized viewing and confirm the settings, control circuitry 304 may instruct the display to present a Synchronization Summary screen 900, shown in FIG. 9. The synchronization summary screen 900 may be displayed after control circuitry 304 has a command from the user that the user is finished inputting schedule information and wishes to confirm the synchronization setup by, for example, a user selection of the Confirm Synchronization button 608 of FIG. 6. The Synchronization Summary screen 900 may be displayed any time between the confirmation of the synchronization setup and before the program is simultaneously viewed in synchronized viewing. For example, if control circuitry 304 receives input that a program scheduled for synchronized viewing was selected in a program guide (e.g., grid program listings display 100 of FIG. 1), control circuitry 304 may instruct the display to present a synchronization summary 900 for the program. At the top of the synchronization summary screen 900, a summary of information 902 of the program selected for synchronized viewing is displayed. Below the program summary section 902, additional information related to the synchronized viewing, such as the scheduled viewing times for invited participants in their respective time zones, the channels on which the program is aired for the respective invited participants, the reminder settings for each of the invited participants in synchronized viewing, and the frequency setting, are displayed. In other embodiments, less information, additional information, or alternative information is displayed in the summary. The contents of the summary section may change over time. For example, if an invited participant declines to participate in synchronized viewing, this may be noted in the summary section, and the information for the participant in the various aforementioned categories may be removed. Similarly, if the user who created the synchronization invitation or another user invites additional participants, information related to the one or more additional participants may be added to the summary.

The synchronization summary screen 900 also includes various buttons 906-914 for receiving input that the user wants to adjust the synchronization settings. If the control circuitry 304 receives a selection of one of these buttons, control circuitry 304 causes the display to present, on a new screen or an overlay, an appropriate user interface for receiving changes to the program, receiving instructions to add or remove buddies, receiving reminder settings for buddies, receiving changes to a reminder setting, or receiving a command to change the frequency of synchronized viewing. Below these buttons is a Done button 916 which, when selected, causes the interactive media guidance application to return to a different screen, such as the grid program listings display 100 shown in FIG. 1.

Once control circuitry 304 receives confirmation of the settings, it transmits one or more synchronization invitations to the selected buddy or buddies and/or group(s). The synchronization invitations may be transmitted over communications network 414. The communications circuitry of the user device may communicate directly with other users' user device(s), which may be one of user television equipment 402, user computer equipment 404, or wireless user communications device 406, to transmit invitations, or the invitations may be transferred through a central server or other centralized system. The user device may receive responses from the invitees via the same communication pathway through which the invitation was sent, such as communications network 414, or via a different communication pathway.

The synchronization invitation includes data related to the program selected, such as the program title, the program time, and the station on which the program airs. In some embodiments, the synchronization indication includes a program identifier with which control circuitry on the receiving user equipment can look up the program information from, for example, guidance data in storage 308 or media guidance data source 418. The synchronization also includes data related to the sender of the invitation, such as name, IP address, email address, telephone number, location, or user profile information. The synchronization may include similar data related to the other invitees.

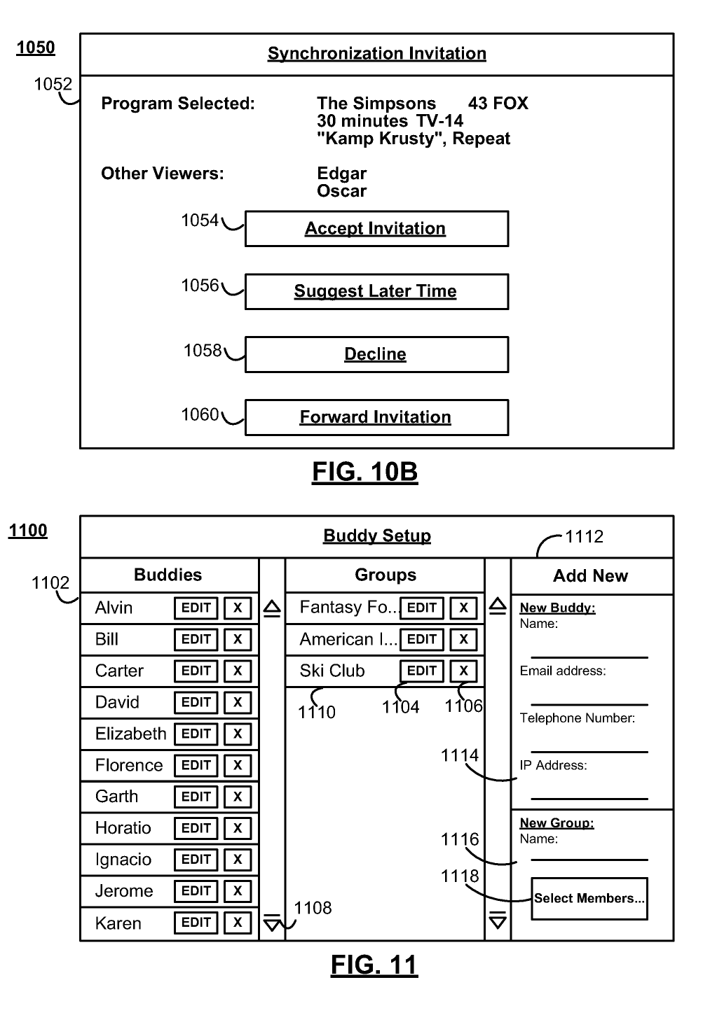

Control circuitry on the receiving user equipment processes the received synchronization invitation to generate Synchronization Invitation screen 1000, shown in FIG. 10A. A synchronization invitation may be viewed on, for example, user television equipment 402, user computer equipment 404, or wireless user communications device 406. The synchronization invitation may be presented on the same user device that will display the synchronized program or a different device. For example, a user who watches synchronized programs on user television equipment 402 may receive synchronization invitations his wireless user communications device 406, since he may be able to respond to invitations more quickly or with greater ease using his wireless user communications device 406 than using his user television equipment 402. In some embodiments, the synchronization invitation is sent to multiple devices associated with a single user. The user may be able to respond to the invitation on any device. In addition to receiving a response to the invitation to send to the inviter, control circuitry 304 of the device may receive an indication of the device on which he will watch the program.

The Synchronization Invitation 1000 includes a synchronization summary 1002, which includes information about the program selected, e.g., the program title, the channel on which the program airs locally, and the time at which the program is scheduled for synchronized viewing. The summary portion of the invitation also displays the other participants. In some embodiments, the invitation includes more detailed status information of the participants, such as indications of the user from which the invitation originated, which users have accepted the invitation, which users have declined the invitation, and which users have not yet responded to the invitation.

Control circuitry 304 of the user device receiving the invitation (i.e., the invitee) causes its associated display to present, below the synchronization summary 1002, options for responding to the invitation, such as a button to accept the invitation 1004, a button to accept the invitation and set a reminder 1006, a button to decline the invitation 1008, and a button to adjust the synchronization settings 1010. When control circuitry 304 of the invitee receives a decision to accept, accept and set a reminder, or decline, control circuitry 304 sends the decision to the other participants. When control circuitry 304 of the invitee receives a decision to accept and set a reminder or adjust the synchronization, it causes a display to present a user interface screen or overlay to the user with which the user can input reminder settings or synchronization setting adjustments. Control circuitry 304 of the invitee sends the synchronization setting adjustments to the other users invited for synchronized viewing. The other users may accept the revised synchronization settings, reject the revised synchronization settings, further adjust the synchronization settings, or decline to participate in the revised synchronization.

In some embodiments, control circuitry may be programmed to generate and send automatic responses to invitations. For example, as instructed by the user, control circuitry 304 may automatically accept invitations from particular users or for particular programs, or automatically decline invitations from particular users or particular programs. In some embodiments, after a user has agreed to participate synchronized viewing of a program, control circuitry 304 may be programmed to decline additional invitations for the same program. Control circuitry 304 may be programmed to decline invitations having synchronized viewing scheduled during a particular time interval, e.g., during the user's work hours, or while the user is on vacation.

In addition to sending and receiving the invitations, control circuitry 304 at the inviting user device and/or the invited user device determines whether it should record the program. In some embodiments, a particular user device should record the program if the time at which the selected program becomes available at that user device is earlier than the time at which the program becomes available at another of the participating user devices. For example, if a user device located in California invites a buddy in New York to simultaneously view a program, the program may become available (e.g., is broadcast) in California after it becomes available (e.g., is broadcast) in New York. In this case, the California viewer is in the latest broadcasting location, and the user device in New York records the program when it is broadcast at an earlier time, e.g., three hours earlier (step 1620).

In order to determine if it should record the program, control circuitry 304 retrieves from storage 308 and/or media guidance data source 418 schedule information indicating when the program will be available to the user device. Control circuitry 304 also receives schedule information of one or more other user devices participating in or invited to participate in synchronized viewing. For example, control circuitry 304 may determine the location of a participating device and, based on the location, retrieve schedule information over the communications network from the media guidance data source 418 or from another provider of schedule information. In some embodiments, control circuitry 304 sends to other invited user devices a request that the other user devices return schedule information. The control circuitry may also send information identifying the program, and may request only the time at which the program becomes available at the respective user devices, rather than all of the schedule information. Control circuitry 304 then may receive the schedule information for at least the program of interest directly from the other user devices.

Once control circuitry 304 has retrieved or received the schedule information that indicates what time the program becomes available (i.e., availability time) in its own location and for the other invited user devices, control circuitry 304 compares its availability time to the availability times of the other user device. Control circuitry 304 may adjust some or all of the availability times to a common time zone, e.g., its own time zone or Coordinated Universal Time (UTC), to perform the comparison. If the result of the comparison indicates that the availability time of control circuitry 304 is before the availability time of at least one other user device, control circuitry 304 automatically schedules the recording of the program. Control circuitry 304 may also be configured to send the results of the comparison to the other user devices. Control circuitry 304 may alternatively or additionally send instructions to automatically schedule the recording of the program to other user devices if the comparison identifies other user devices with an availability time before the availability time of at least one user device. In some embodiments, the above described process of determining which user device(s) should record the program is performed by a central server, and the central server sends instructions to automatically record the program to the applicable user devices.

Once the program has become available to all of the user devices, the program is synchronized as the program is being transmitted to the user device with the latest availability time. During synchronization, the device or devices with the latest availability time display the program as it is transmitted, while the other device or devices display the program from storage 308. At the scheduled time for synchronized display of the program (i.e., the latest availability time), the user devices may automatically begin displaying the synchronized program, or one or more of the participants may need to input a command to tune to the program or otherwise begin participating in synchronized viewing.

The user device at which the program becomes available last may change in between the initial scheduling of the synchronization and the time that the synchronization occurs. For example, participants may be invited in three locations in which a program becomes available at 7:00 pm EST in a first location, at 8:00 pm EST in a second location, and 9:00 pm EST in a third location. The participants are scheduled to all view the program at 9:00 pm EST. Initially, the third location is where the program becomes available last. If all of the users in the third location decline to participate, the second location becomes the location in which the program becomes available last. In this case, the remaining participants can view the synchronized program at the originally scheduled time (9:00 pm EST), or they may watch the program at 8:00 pm EST. If they advance the viewing to 8:00 pm EST, the user devices in the second location may access the program as it is broadcast rather than accessing the recorded program from storage. In another example, if the participants in the third location accept the invitation and invite a participant in a fourth location in which the program becomes available at 10:00 pm EST, the scheduled viewing time for all of the original participants shifts 1 hour later, and the user devices in the third location are no longer in the latest location in which the program becomes available. Therefore, the user devices at the third location would record the program as it is made available.

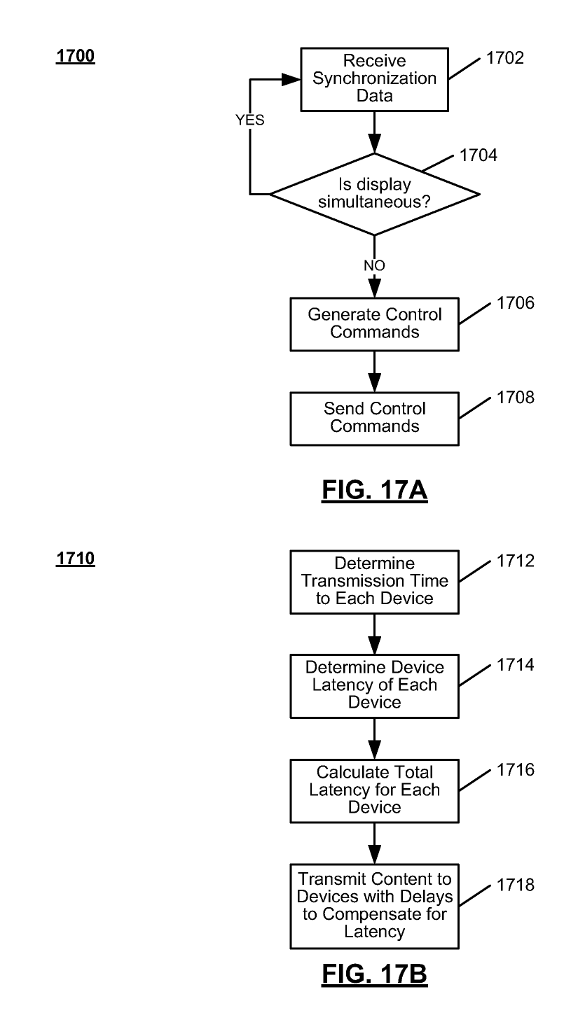

In some embodiments, the synchronization is not an invitation for future viewing, as described above, but rather is an invitation for immediate viewing. In such an embodiment, the program is already available to all the participating user devices. The program may have already been recorded by all of the participating user devices. Alternatively, the program may have been recorded on at least one of the participating user devices but less than all of the participating user devices, and the user device(s) which have not recorded the program may receive or stream the recorded program from one or more of the user devices which have recorded the program. In yet other embodiments, the program is available at a central server, and one or more of the participating user devices receives or streams the program from the same central server or multiple cooperating servers. In such embodiments, the program may be a live broadcast, such as a sports game or an awards show. In embodiments wherein multiple user devices receive the program from a single location, either from a user device or from a central server or servers, circuitry of the user device or central server(s) controls delivery of the program so that the program, as received by each of the user devices, is synchronized. The synchronization of a program received at different user devices from a single location is described further in relation to FIG. 17B.

An invitation for immediate viewing 1050 is shown in FIG. 10B. FIG. 10B is similar to FIG. 10A, but, since the program is already available to all of the viewers, the time at which the program becomes available to the receiving viewer and the times at which the program becomes available to the viewers Edgar and Oscar is not included, as they were in FIG. 10A. Instead, the information of the program selected may here simply include the duration of the program. Furthermore, the response options for the invited user may be simplified, since some of the response options described in relation to FIG. 10A, such as the reminder feature, may not be relevant for an invitation for immediate viewing. The available responses displayed by control circuitry 304 on display 312 of the invited user device include “Accept Invitation” 1054, “Suggest Later Time” 1056, “Decline” 1058, and “Forward Invitation” 1060.

A response to accept the invitation using button 1054 would cause the synchronization to be begin when responses have been received from all invited user devices. There may be a predetermined time period, such as five minutes or ten minutes, after which the synchronized viewing begins, even if one or more invited user devices has not responded to the invitation. The invitation may include the time until the synchronized viewing begins, which may count down on a timer displayed on display 312. The inviting user may be able to set the duration of the time period.

If control circuitry 304 of the invited user device receives a selection of button 1056, control circuitry 304 causes the display 312 to present a user interface screen or overlay to the user with which the user can input a suggested later synchronization time, which the control circuitry 304 sends via network 414 to the inviting user device. If control circuitry 304 of the invited user device receives a selection of button 1058, the invited user device does not participate in the synchronized viewing. If control circuitry 304 of the invited user device receives a selection of button 1060, control circuitry 304 causes the display 312 to present a user interface screen or overlay to the user with which the user can input additional buddies or groups to whom to forward the invitation.

The user of the interactive media guidance application may wish to add buddies or groups or otherwise modify the buddy and/or group lists. A Buddy Setup screen 1100 for modifying buddies and groups is shown in FIG. 11. The Buddy Setup screen 1100 includes a section displaying a list of buddies 1102, a section displaying a list of groups 1110, and a section for adding a new buddy or group 1112. The buddy list 1102 and group list 1110 can be navigated using, for example, scroll bars 1108 if a user has more buddies or groups than can be displayed on the screen. Information for each of the buddies and groups can be edited by selecting an edit button 1104. When control circuitry 304 receives a selection to edit a buddy, control circuitry 304 causes the display to present a user interface on a new screen or an overlay with which the user can input, for example, a change in the name or contact information of a buddy. When control circuitry 304 receives a selection to edit a group, control circuitry 304 instructs the display to present a user interface on a new screen or an overlay with which the user can input, for example, additions or deletions to group members, or changes in names of group members and/or contact information of group members. The Buddy Setup screen may also include a way for a user to delete buddies or groups. For example, the Buddy Setup screen 1100 includes an “X” 1106 next to each buddy and group; selecting the “X” 1106 causes control circuitry 304 to delete the buddy or group. Control circuitry 304 may instruct the display to present a confirmation screen or overlay before a buddy or group is deleted.

The section for adding a new buddy or group 1112 includes a New Buddy section 1114 and a New Group section 1116. In the New Buddy section 1114, the user can enter the name and contact information, such as email address or telephone number or the buddy, and/or IP address of the buddy's user equipment. The contact information allows control circuitry 304 to send synchronization invitations to the buddy via a communications channel, and it may enable the user device to communicate with the buddy's user device during synchronized viewing. In some embodiments, control circuitry 304 generates a notification to a new buddy that the user has added the new buddy and instructs the user device to send the notification to the new buddy. The new buddy may need to confirm an invitation that he wants to be added as the user's buddy. This may also cause the new buddy's control circuitry to add the inviting user as a buddy. In the New Group section 1116, the user can input a name for the new group and select a Select Members button 1118. When control circuitry 304 receives a selection of the Select Members button 1118, control circuitry 304 instructs the display to present a user interface on a new screen or an overlay with which the user can select buddies to add to the group.

In some embodiments, the systems and methods described herein relate to control circuitry 304 that notifies users if another viewer with which they are scheduled for synchronized viewing has already viewed a program or a portion of a program. Control circuitry 304 may even prevent a viewer who has seen a program from engaging in synchronized viewing of that program at the scheduled time. This prevents viewers who have already watched, for example, a game show or a drama, from providing answers to puzzles or questions that the user learned in a previous viewing or spoiling the plotline of a drama for the other viewers. To avoid accidental viewing of a program scheduled for synchronized viewing, control circuitry 304 can provide a warning to the user if he attempts to view such a program. For example, a program guide screen 1200 including a warning overlay screen 1206 for warning a user that the user is attempting to view a program scheduled for later synchronized viewing is shown in FIG. 12.

To help safeguard a viewer from the consequences of viewing a program before it is scheduled for synchronized viewing, the interactive media guidance application displays an on-screen warning 1206 if the user attempts to watch the program by, for example, selecting the program in a program guide 1202, entering the channel on a user input device, e.g., a remote control, selecting the program from a list of available programs, or purchasing a pay-per-view program. The warning screen 1206 provides information about the scheduled viewing and accepts input indicating whether the interactive media guidance application should cause the program to be presented.

Despite such a warning, a user may still decide to watch a program before its scheduled time for synchronized viewing. So, control circuitry 304 monitors the programs being viewed on the device to determine whether the device is displaying or has already displayed the program scheduled for synchronized viewing before the scheduled time for synchronized viewing. If control circuitry 304 determines that the viewer has viewed the program ahead of the scheduled time, control circuitry 304 automatically sends an alert to the other devices scheduled to participate in synchronized viewing. In some embodiments, this information is registered or stored at a central database for retrieval by the other user devices. User devices may able to determine whether another user device has viewed a program without the other user device transmitting an alert.

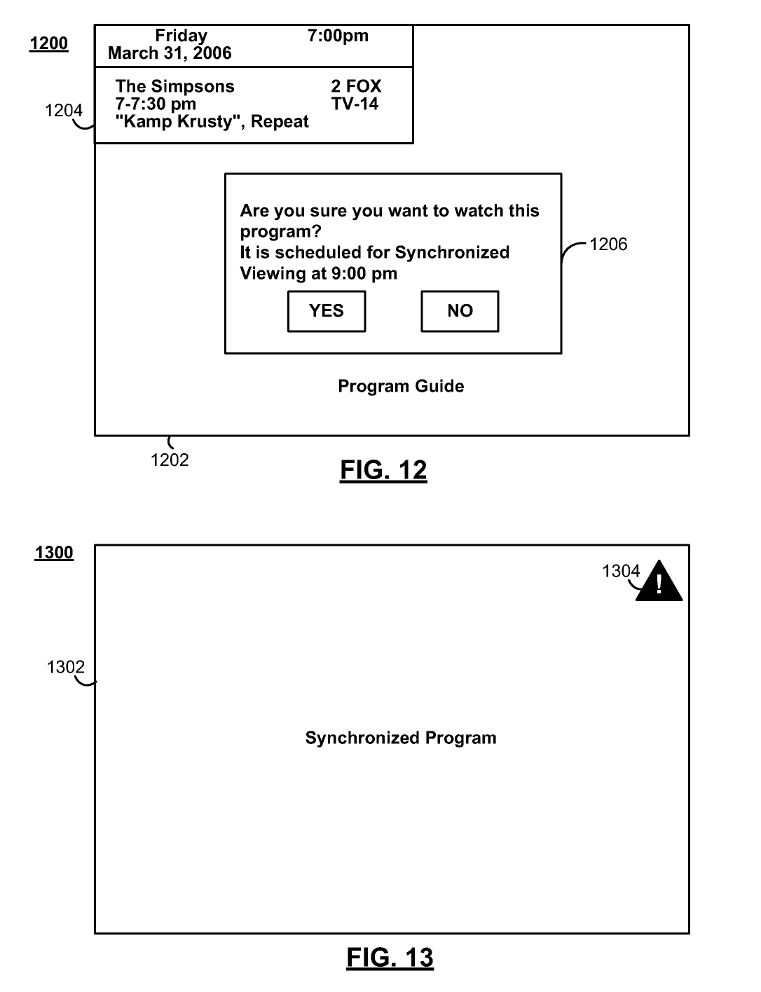

When control circuitry determines or receives an indication that another user device has viewed the program, control circuitry 304 may present a warning indicator as shown in FIG. 13 as the synchronized program is being displayed. The warning indicator indicates to the viewer that a user participating in synchronized viewing has already watched all or part of the program and is still engaging in the synchronized viewing. Control circuitry 304 may receive a selection indicating that the user would like to view more information related to the warning. Such a selection may be received from a user input device with which the user can, for example, click or scroll over the warning indicator or press a particular button. Receiving a user selection that the user would like to see more information related to the warning causes control circuitry 304 to instruct the display to present, on an overlay screen or new screen, names of viewers who have watched the program, how much of the program they watched, and/or other pertinent information. If only a portion of the program has been viewed previously by one or more participants, control circuitry 304 may cause the warning indicator to be removed after the segments that have already been viewed during the synchronized viewing. In other embodiments, warning indicator 1304 includes an indication of which other viewers have watched the program and/or other pertinent information.

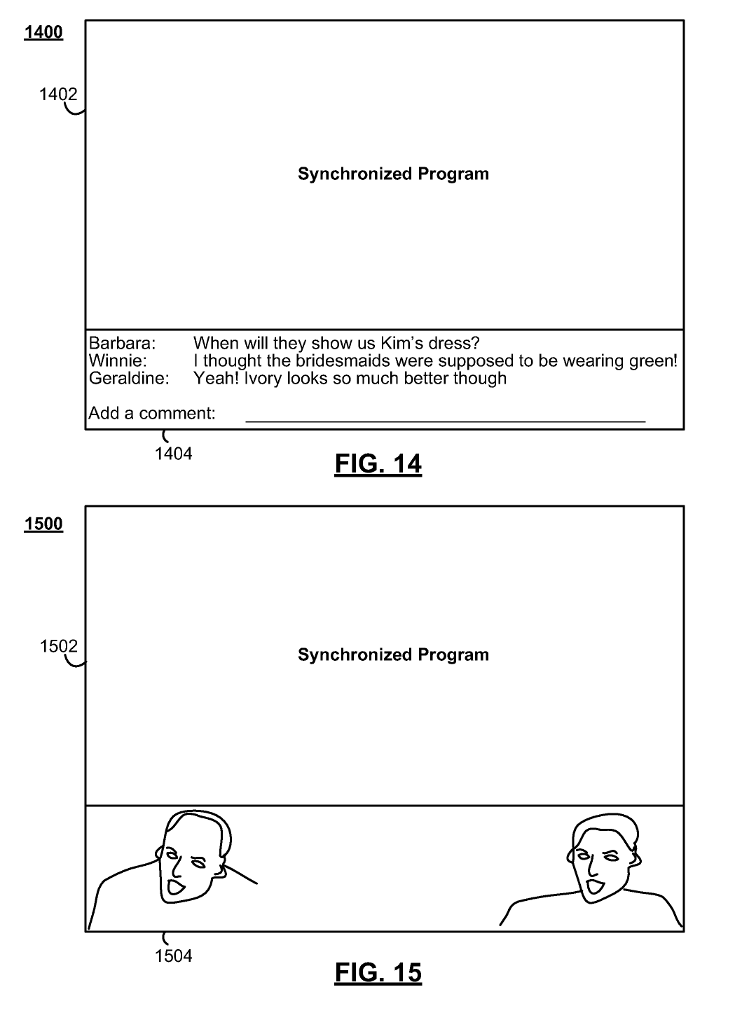

Control circuitry 304 and communication paths may enable interactive communication between viewers participating in synchronized viewing. Two illustrative display screens 1400 and 1500 showing interactive synchronized viewing are shown in FIGS. 14 and 15. In each case, a portion of the screen is used for interacting with other users engaged in synchronized viewing. Control circuitry 304 may cause the display of the program to be resized, either to scale or not to scale, above the interaction portion of the screen. Alternatively, the interaction portion may be laid over top of the program, which is not resized, and the interaction portion may be partially transparent. The interaction portion need not be below the synchronized program, but may be above it, to the side, or on a different display entirely.

The display screen 1400 shown in FIG. 14 includes a text commentary portion 1404 where users can enter text comments using, for example, a keyboard, a touch pad, an on-screen keyboard, or telephone text entry. The display screen also shows the comments of other users engaged in the synchronized viewing. The display screen 1500 shown in FIG. 15 includes a video chatting portion 1504 where users may view and listen to other participants. The user equipment may include a camera and a microphone so that the user may participate in video chatting. Control circuitry 304 may allow a user to mute and/or remove the image of one or more of the other viewers participating in the synchronized viewing.

In a specific embodiment, the program is a video provided to a first user device and a second user device via a first and second video-on-demand (VOD) provider, respectively. A VOD provider may be, for example, a cable provider, a satellite provider, or an internet provider. In some embodiments, one or more of the VOD providers may be a streaming media service. For example, the first user device may access a subscription to a first VOD provider (e.g., HULU PLUS), and the second user device may access a subscription to a second VOD provider (e.g., TIME WARNER CABLE VOD). A synchronization application, described below, may run on the user devices to enable synchronization of a retrieved VOD. A particular program may be available from the first VOD provider before becoming available from the second VOD provider. In this embodiment, the availability may not be based on the location in which the user device is located. Neither user device records the program when it becomes available, since the user devices can access the stored video on command from their respective VOD providers.

A user may instruct control circuitry 304 of a particular scheduled time for synchronized viewing, wherein the scheduled time is after the time at which the program is expected to be available from both VOD providers. In other embodiments, the scheduled time may be the time at which the video becomes available from by the second VOD provider. The time at which a program becomes available by one or both VOD providers may not be known. In such a case, control circuitry can be instructed to generate an alert for one or both of the users when the program becomes available. The users can then opt to either immediately view the program or schedule a later time for synchronized viewing of the program. When synchronized, each video accesses a streaming version of the program or video from their respective VOD provider.

As described above in relation to FIG. 12, if control circuitry 304 in the first user equipment receives a request to access the program ahead of the scheduled time for synchronized viewing or before it becomes available by the second user equipment, control circuitry 304 of the first user equipment may generate a warning and instruct that the warning be displayed. The user can then decide whether or not to view the program. If the user decides to view the program, control circuitry 304 at the second user device may receive an alert that the program has been viewed. Such an alert may take the form of a warning indicator as discussed in relation to FIG. 13.

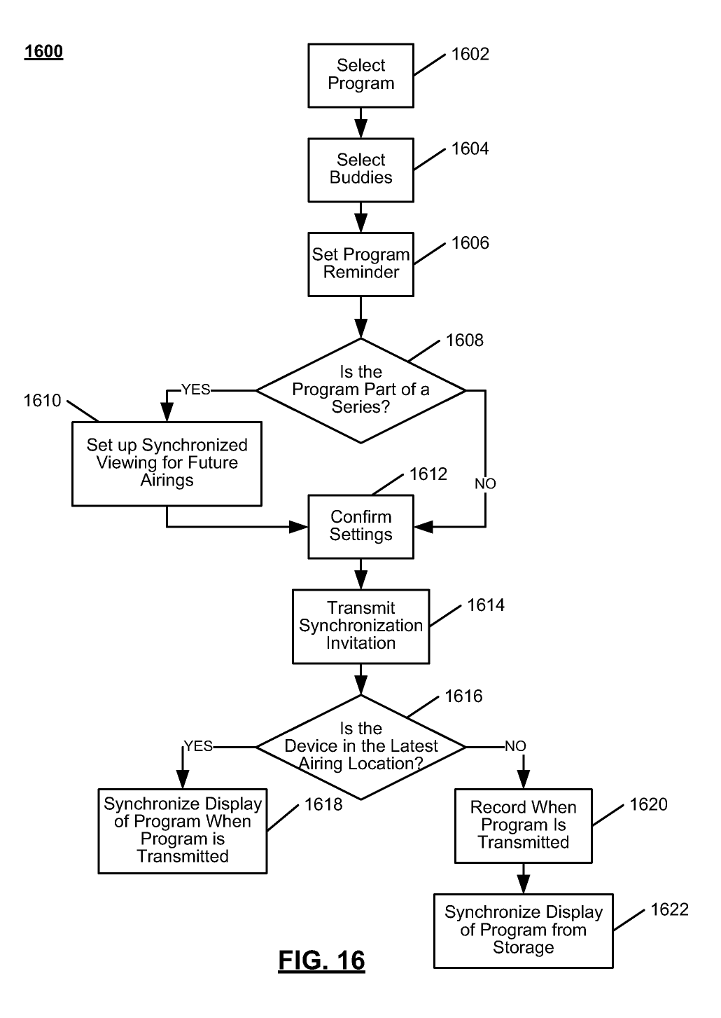

A VOD application for accessing VODs supplied by a VOD provider may or may not enable cross-platform synchronization. In some cases, since the VOD application may not be configured for synchronizing a VOD with a video accessed by any other user device, let alone a video accessed by another user device from a different VOD provider, control circuitry 304 may access a synchronization application that enables the synchronization of a retrieved VOD with a video accessed by another user device. The synchronization application provides instructions with which control circuitry 304 can access and, in some embodiments, display a video feed from a VOD application running on the same user device as the synchronization application. The synchronization application may also provide instructions with which control circuitry 304 can synchronize the program being displayed on the first user device with the program being displayed on the second user device using data retrieved from a second user device. Techniques for synchronizing the display of a program are discussed below in relation to steps 1618 and 1622 of FIG. 16.

FIG. 16 shows an illustrative process 1600 for setting up and engaging in synchronized viewing. The process includes receiving information related to the program for synchronized viewing, the other participants for synchronized viewing, a reminder request, and a synchronized viewing frequency of the program (steps 1602-1610). The process then involves sending a synchronization invitation and, in some cases, recording the program (steps 1614, 1616, and 1620). The process further involves synchronizing the program (steps 1618 and 1622).

Control circuitry 304 in a user device receives from user input interface 310 user input indicating a program to be scheduled for synchronized viewing (step 1602). For example, control circuitry 304 may instruct display 312 to present a user interface for receiving a user selection in a program in a program guide, as described in reference to FIG. 5. In some embodiments, control circuitry 304 may alternatively cause display 312 to present a list of all available programs, a list of recently released programs, a list of pay-per-view programs, a list of a user's favorite programs, or any other list or other representation of programs. Control circuitry 304 may provide an interface on display 312 that allows a user to search for programs using, for example, titles, actors, or keywords using user input interface 310.

Control circuitry 304 may also receive from user input interface 310 user input indicating one or more buddies or groups to be invited to participate in synchronized viewing (step 1604). For example, control circuitry 304 may provide a user interface via display 312 for receiving via user input interface 310 a user selection of buddies or groups, as described above in reference to FIG. 7. In some embodiments, control circuitry 304 may provide a list of favorite buddies and/or groups. Control circuitry 304 may determine and instruct display 312 to present a list of buddies and/or groups that it predicts a user will want to invite based on participants in the user's previous synchronized viewing. Furthermore, once control circuitry 304 receives one or more selections of buddies or groups from the user via user input interface 310, control circuitry 304 determines and causes the display of suggested additional buddies that the user is more likely to want to invite based on the buddy or buddies already selected.

Control circuitry 304 may also receive from a user via user input interface 310 a request to receive a reminder for the synchronized viewing (step 1606). For example, control circuitry 304 may provide a user interface on display 312 for receiving via user input interface 310 a request for a reminder as described in reference to FIG. 8. Control circuitry 304 may also provide a user interface on display 312 for receiving via user input interface 310 a reminder communication method preference from a user. For example, the user may be able to select to receive a reminder on user television equipment 402, user computer equipment 404, wireless user communications device 406, an alarm clock, or another device for transmitting a reminder. The user can select that a reminder be automatically created for invitees.

Control circuitry 304 may determine whether the selected program is part of an ongoing series (decision 1608). If the program is part of a series, control circuitry 304 may receive from a user via user input interface 310 an indication of a frequency with which the program should be scheduled for synchronized viewing (step 1610). For example, control circuitry 304 may provide a user interface on display 312 for receiving via user input interface 310 a request to schedule the program for synchronized viewing a single time, each time any episode in the series is aired, or each time a new episode of the series is aired, as described above in reference to FIG. 8. For example, the program may be part of a series, a miniseries, or a movie series (e.g., a trilogy). If the program is a sports event, control circuitry 304 may receive a request from the user that similar sports programs be scheduled for synchronized viewing. For example, if a user is scheduling synchronized viewing of the New York Jets vs. the New England Patriots, control circuitry 304 may allow the user to request via user input interface 310 that all New York Jets games be scheduled for synchronized viewing. Similarly, control circuitry 304 may allow other types of programs having a common theme or participants, such as award shows or stand-up comedy programming featuring a particular comedian, to be scheduled as a group for synchronized viewing even though they are not part of a series.

Steps 1602 through 1610 do not have to be performed in the order shown in FIG. 16, but can be performed in any order. Additionally, one or more of the steps 1602 through 1610 may be omitted. Once information related to some or all of the program, buddies and/or groups, reminder, and frequency of the program selected for synchronized viewing have been received, control circuitry 304 may seek a user confirmation of the synchronization selections (step 1612). For example, control circuitry 304 may instruct display 312 to present a Synchronization Summary screen 900 as described in relation to FIG. 9. When control circuitry 304 receives via user input interface 310 a selection of “Done”, the synchronization is considered confirmed and synchronized viewing is scheduled.

Once control circuitry 304 receives confirmation, it transmits synchronization invitations to the selected buddy or buddies and/or group(s) via communications network 414 (step 1614). The user device may communicate directly with other users' user device(s) to transmit invitations, or the invitations may be transferred through a central server or other centralized system. The user device may receive responses from the invitees via the same communication pathway of communications network 414 through which the invitation was sent or via a different communication pathway.

Control circuitry 304 determines whether it is running on a user device on which the program becomes available the latest of the participating user devices by comparing the time at which the program becomes available at the user device to the time(s) at which the program becomes available at other participating user devices (decision 1616). For example, if a user device located in California invites a buddy in New York to simultaneously view a program, the program may become available (e.g., is broadcast) in California after it becomes available (e.g., is broadcast) in New York. In this case, the California viewer is in the latest broadcasting location, and the user device in New York records the program when it is broadcast at an earlier time, e.g., three hours earlier. The program is then synchronized as the program is being transmitted to and received by the user device in California (step 1618). At the scheduled time for synchronized display of the program, the user devices may automatically begin displaying the synchronized program, or one or more of the participants may need to input a command to tune to the program or otherwise begin participating in synchronized viewing.

On the other hand, if the user device located in New York invites a buddy in California to view a program, the program may be broadcast in New York before it is broadcast in California. So, the user device in New York is not in the latest broadcast location. In this case, control circuitry 304 of the user device in New York send an instruction via communications network 414 to the user device in New York to record the program when it is transmitted (step 1620), and the stored program is synchronized with the program being broadcast in California as it is being broadcast (step 1622).

A program recorded, aired, or otherwise transmitted in one location may not line up precisely with a program recorded, aired, or otherwise transmitted in a second location, even if the first and second locations are in the same time zone. For example, the lengths of the advertisements of programs available to different users or in different locations may differ, or the speed at which the program is displayed may be slightly faster or slower at one location than another. The display of a program by a first user device may be offset in time from the display of the same program by a second user device because of different transmission times to user devices and/or internal latencies of the user devices. If the connection over which a program is being transmitted has any instability, the instability may create an interruption or delay in the data stream. Therefore, the user devices may coordinate to ensure simultaneous display of the program. In some embodiments, user devices are configured to communicate directly with other user devices in one or more other locations via communications network 414. In such embodiments, control circuitry 304 on a first user device may be a “synchronization master” for coordinating the viewing. For a particular program scheduled for synchronized viewing, the synchronization master may be the user device that scheduled the synchronized viewing, the user device with the most advanced processor, the user device that is the most centrally located geographically, the user device with a particular software package for carrying out the functions of a synchronization master, or selected for some other reason. The synchronization master can be selected by the device that scheduled the synchronized viewing, self-appointed, selected by a central server, or selected by a user.

FIG. 17A shows an illustrative process 1700 for using the synchronization master to synchronize viewing on multiple devices. The synchronization master may receive, from the other participating user devices via communications network 414, synchronization data that allows the synchronization master to automatically maintain the synchronized viewing for the participants (step 1702). For example, the synchronization data may include information indicating a particular screen or segment and the time at the screen or segment was or will be displayed so that the synchronization master can compare the screens or segments displayed by particular devices at a particular time. In other embodiments, the synchronization master determines or receives an indication of the amount of time it takes for data to be received from the other participating devices, i.e., the communication delays in communications network 414 between each participating device and the synchronization master. This way, the synchronization master can determine the time at which a screen or segment was displayed by subtracting the communication lag from the time that the information related to the screen or segment was received at the synchronization master. If a participating user device is playing a recording rather than displaying a program as it is being transmitted, control circuitry 304 on the participating user device may automatically send synchronization data related to at least the display speed and advertisement timing of the recording to the synchronization master before the program and/or advertisements are displayed. This may improve the synchronization, and it may reduce the processing demand on the synchronization master.

Once the synchronization master has received synchronization data from the other participating user devices, the synchronization master uses the received synchronization to compare the currently display at the devices and determine whether or not the user devices are displaying the program simultaneously (decision 1704). As long as the display is simultaneous, the synchronization continues receiving and analyzing synchronization data (steps 1702 and 1704). If the display is determined to no longer be simultaneous, e.g., if an advertisement displayed by a first user device is longer than an advertisement displayed by a second user device, the synchronization master automatically generates control commands (step 1706) and sends the commands via communications network 414 to some or all of the user devices (step 1708) to cause the receiving user device(s) to adjust the display of the program. In the aforementioned example, the synchronization master may generate and send a command to the first user device to fast forward or skip through the advertisement or a command to the second user device to rewind and/or pause until the program displayed at the first user device catches up, or the synchronization master may generate and send both types of commands. The synchronization master also may generate commands for its own program display.

To accommodate the display of a program as it is being aired or otherwise transmitted in real-time, a user device may include a buffer that enables minor adjustments in the display of the program. In some embodiments, the control circuitry 304 instructs the user device to record the program as it is being aired and as it is being synchronized; in this case, the display of the stored program can be adjusted.

In some embodiments, a central server or a plurality of servers coordinates the synchronized viewing. In this case, the central server or servers may perform some or all of the functions described above in relation to the synchronization master.

As described in relation to FIG. 10B, the invitation may be an invitation for immediate viewing rather than future viewing, and the program received by multiple user devices may come from the same source, e.g., a single user device or a central server. In such embodiments, the process for setting up synchronized viewing may be similar to process 1600. However, the process for setting up immediate viewing may not include step 1606, set program reminder, as this would not be relevant for immediate viewing. The process for engaging in synchronized viewing may also be different. Rather than each user device receiving a different instance of the program, either from storage or as it is being broadcast, multiple user devices receive the same instance of the program from a single location. In this case, the device or server from which the program is received is the synchronization master. In this embodiment, rather than the synchronization master receiving information about the viewing of the program at the user devices and aligning the viewing of the program with control commands sent to the user devices, the synchronization master adjusts the transmission of the program from the synchronization master to the participating user devices. The operation of the synchronization master is described further in relation to FIG. 17B.

The program may be recorded by a participating user device and transmitted via communications network 414 to other participating user devices for immediate viewing at each of the participating user devices. Alternatively, the program may be made available for immediate viewing by media content source 416. In such embodiments, the program may be made available for immediate viewing (i.e., on demand) to all user devices after the program has been initially aired in all locations, or it may become available in a particular location after the program has been aired in that location, even if the program has not been aired yet in another location. In some embodiments, a user device may be able to access a program for synchronized viewing from a media content source 416 before the program has aired in the location of the user device. For example, a first user desiring to participate in synchronized viewing with a second user in a location in which the program has already aired may be given special permission to access the program before it has aired in the first user's location. As programs are aired at one or more locations, media content source 416 may record the programs and make them available to users, such as through a service that allows the user device to access a program currently being aired from the beginning of the program. In some embodiments, such a service makes any program that has begun airing within a certain time frame, such as the past day, the past week, or the past two weeks, available for access. In yet other embodiments, media content source 416 may allow user devices to access a program for synchronized viewing before the program was originally aired in any locations. In some embodiments, the media content source 146 comprises two or more servers in communications with each other. The servers, which may be in different locations, are able to synchronize the transmission of a program to different user devices so that the user devices display the program simultaneously. In such embodiments, the synchronization master may comprise one of the servers, which controls other central servers and/or proxy servers for transmitting the program to user devices, or the synchronization master may comprise multiple servers.

FIG. 17B shows a process 1710 for using a synchronization master to transmit a program from the synchronization master to at least one other device for synchronized viewing. Because participating user devices may receive the program by different transmission schemes or may be at different locations (e.g., different locations in the same room, different rooms in the same household, or in different states), the time to transmit the program from the synchronization master to a first participating user device may be different from the time to transmit the program to a second participating user device. If the synchronization master transmits a segment of the program to the first and second user devices at the same time, the first and second user devices may display the segment at slightly different times, which is undesirable. The user devices may also add device latencies, such as a latency for decoding the received program (i.e., a decoding latency), a latency for buffering the received program (i.e., a buffer latency), a latency for writing the program to memory and reading the program from memory (i.e., a storage latency), and/or any other latencies specific to user devices. To correct for these latencies, the synchronization master can delay the transmission of the program to one or more of the participating user devices. To do this, the synchronization master determines the latency to each participating user device (steps 1712-1716) and adds a delay in the transmission to the participating user devices based on the determined latencies so that, when the participating user devices play the program, the program is synchronized between the user devices.

At step 1712, the synchronization master determines the transmission time to each participating user device. The transmission time is a property of the network, and it can be determined at the synchronization master by pinging each device. The synchronization master sends an echo request packet via a transmission path to a user device. The user device receives the echo request and sends an echo reply to the synchronization master via the same transmission path. The user device performs no packet processing when pinged, so the synchronization master can calculate the transmission time from the synchronization master to the user device as one half of the time it takes to receive a response from a user device. Alternatively, rather than pinging the user devices, clocks at the synchronization master and each user device can be synchronized, and a message can be sent from the synchronization master to a user device. The message may include the time at which the message was sent. The user device receives the message and subtracts the time at which a message is sent by the synchronization master from the time at which the message is received at a user device. This time difference is the one-way transmission latency between the synchronization master and that user device. Alternatively, a message can be sent from a user device to the synchronization master, and the synchronization master can similarly subtract the sent time from the received time to determine the one-way transmission latency. Alternatively, any other method for determining the transmission latency can be used.

At step 1714, the synchronization master determines the device latency of each participating user device. The decoding time is a property of the participating user device, and may include a decoding latency, a buffering latency, a storage latency, and/or any other latency or latencies introduced by a user device. To determine the device latency, the synchronization master may be able to access from a database the device latencies of various devices. In this case, the synchronization master may query the user device to determine the model of the device, and look up what the device latency associated with the device model is in the database. Alternatively, the synchronization master may be able to query the user device or send a test to the device to determine the device latency of the user device. If the synchronization master is one of the participating user devices, the latency to the synchronization master may be zero, negligible, or some or all of the device latency of the synchronization master, depending on whether the program is decoded, stored, and/or buffered at the synchronization master, or if any other processing is performed.

Once both the transmission latency and the device latency are known, the synchronization master calculates the total latency for each device by adding the transmission latency to the device latency (step 1716). Any other potential latency may be included in the total latency. During synchronization, the synchronization master transmits the program to the user devices with delays according to the determined total latency (step 1718). The synchronization master may transmit the program with no delay to a first user device having the highest total latency. In this case, for a second user device, the synchronization master delays the transmission of the program by the difference between the total latency of the first user device and the total latency of the second user device. The delays for any other participating user devices are similarly determined.

In another embodiment, the synchronization master transmits the program to all user devices simultaneously, without adding any delay to the transmission of any of the devices. To synchronize the viewing, each user device either receives from the synchronization master an indication of its own total latency, or it determines its own total latency in a manner similar to steps 1712-1716 described above. The user device also receives from the synchronization master or from the other participating user devices the total latencies of the other user devices. Based on the total latencies of the set of user devices, each user device may delay the display of the program so that the program is synchronously displayed on all of the user devices. Each user device may delay the display by the difference between the highest total latency and its own total latency. In this case, rather than receiving the total latencies of all of the participating user devices, each user device may only receive the total latency of the user device with the highest total latency. The user device may comprise a buffer to enable the delay of the display of the program after it is received.

For example, a synchronization master may be transmitting a program to three user devices for synchronized viewing at the user devices. The synchronization master pings all three of the devices as described above, and the synchronization master determines that the transmission time to the first device is 1 seconds, the transmission time to the second device is 1.5 seconds, and the transmission time to the third device is 4 seconds. The synchronization master also queries the three devices for their device latencies. The first user device returns a device latency of 1 second, the second user device returns a device latency of 0.5 seconds, and the third user device returns a device latency of 1 second. The total latencies of the three devices are 2 seconds, 2 seconds, and 5 seconds, respectively. Since the total latency of the third user device is 3 seconds longer than the total latencies of the first and second user devices, the synchronization master transmits the program to the first and second user devices at a 3 second delay relative to the transmission to the third user device.

In another example, the second and third user devices receive the program from the first user device, which had recorded the program when it was aired to the first user device. The first user device transmits the program to the second and third user device at the same time, and the individual user devices may add delays as needed to correct for the latencies. To determine the transmission latencies, the clock of the first user device synchronizes with the clocks of the second and third user devices, and the first user device sends a message containing a sent time to the second and third user devices. The second and third user devices receive this message and compare the sent time to the time at which they received the message to determine the transmission latency from the first user device. In this example, the second user device determines that its transmission latency is 1 second, and the third user device determines that its transmission latency is 2 seconds. As in the previous example, the second user device has a device latency of 0.5 seconds, and the third user device has a device latency of 1 second. So, the total latency of the second user device is 1.5 seconds, and the total latency of the third user device is 3 seconds. Since the first user device is storing the program, in this example, the total latency of the first user device is negligible. The user devices communicate their latencies to each other over communications network 414. The user devices determine a delay to add to the display of the program based on the difference between the highest total latency, which in this case is 3 seconds, and their own total latencies. Accordingly, the first user device displays the program with a delay of 3 seconds, the second user device displays the program with a delay of 1.5 seconds, and the third user device displays the program with no delay. The delay may be added using a buffer.

In some embodiments, a user device additionally or alternatively outputs an audio signal that is synchronized with a program. For example, the user device may be configured to play a voiceover that is in a different language from the program. In this case, the synchronization master may receive both the program and an audio signal, which may be, for example, a streamed signal or an audio file. In some embodiments, the synchronization master is in connection with a database for storing audio files that the synchronization master can retrieve. The user device may provide a user interface for displaying a list of available audio files to a user and receiving input from the user indicating a particular audio file to be played concurrently with a program. The audio file or audio signal contains synchronization data that indicates how the audio file should be aligned with a program, e.g., information indicating a particular screen or segment of the program to which a particular point in or segment of the audio corresponds. Based on the synchronization data, the synchronization master can continually or periodically compare the program being transmitted to the audio signal being transmitted. If the synchronization master is a user device, the user device can continually or periodically compare the program being displayed by the user device to an audio file being played or streamed by the user device. In some embodiments, the synchronization master combines the program signal and the audio signal and transmits the combined signal.

If the start of the audio file is not offset from the start of the program, the audio file can be played simultaneously with the program without adjustment. Otherwise, the synchronization master may compare synchronization data of the audio file to synchronization data of the program to align the start of the audio to the program. If the program has a period of time for which an audio file is not available, such as during an advertisement, the synchronization master can pause the transmission of the audio signal and resume transmission of the audio file after the advertisement has been transmitted. In some embodiments, the playback speed of the audio file may not be the same speed as the program, so the playback speed of either the audio file or the program may be adjusted by the synchronization master.

In some embodiments, the audio signal may be created as the program is being transmitted to a user device. For example, a sports commentator may provide commentary during a live sporting event, or an instructor may provide explanation to an educational program, such as an educational program or a slideshow presentation. If the person creating the audio signal receives a program signal at the same or nearly the same time as the user device receiving the audio signal, a noticeable amount of time may elapse between the time that the program signal is received by a user device and the time that the audio signal is received by the user device. If the receiving user device outputs both the audio signal and the program signal when they are received, the program and audio may be noticeably offset. This may be the case any time the user device receives an audio signal and a program signal from different sources. Furthermore, even if a receiving user device receives a program signal and an audio signal at exactly the same time, the device latency for processing a program signal may be different from the device latency for processing an audio signal, creating an offset when they are output. Thus, the synchronization master may align the program and audio signal to remove this offset. In some embodiments, the user device includes a buffer for buffering the program signal and/or the audio signal.

In some embodiments, the synchronization master creates a combined, aligned signal based on synchronization data that indicates how the audio file should be aligned with a program. The synchronization master may transmit the combined signal to one or more user devices. In some embodiments, the synchronization master aligns the program to the audio signal based on the difference between the time at which the synchronization master begins receiving the audio signal and the time at which the synchronization master begins receiving the program. The difference in initial receipt times may be based on the transmission latency from the program source and the transmission latency from the audio source, and the relative times at which the program source and the audio source begin transmitting the program and audio signals, respectively.

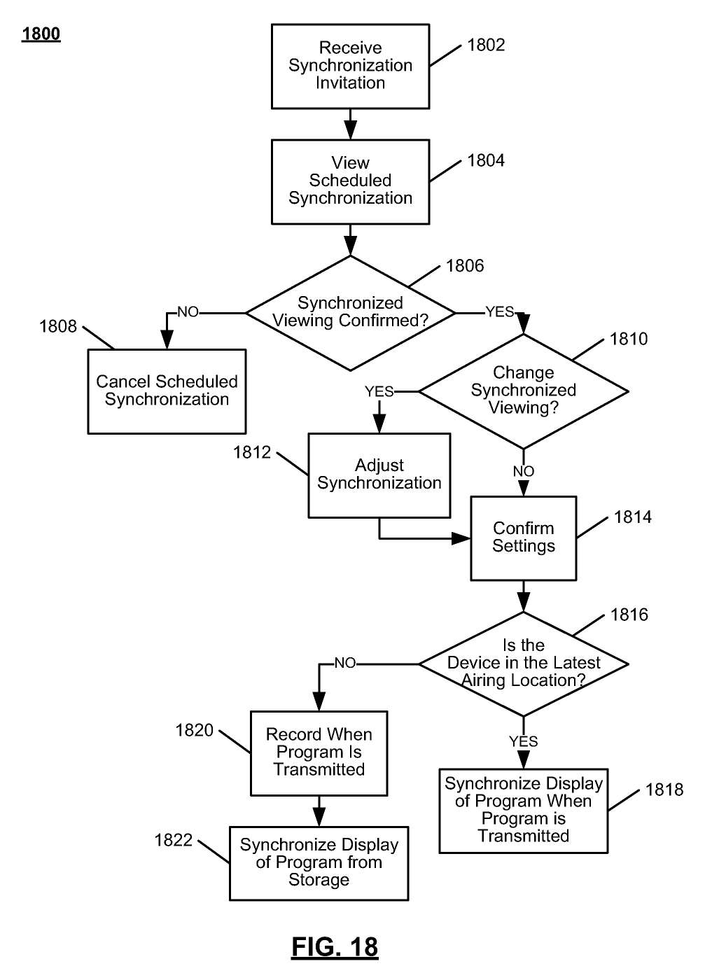

FIG. 18 shows an illustrative process 1800 for receiving and responding to a synchronization invitation and engaging in synchronized viewing. The process includes receiving and displaying an invitation for synchronized viewing of a program (steps 1802 and 1804). The process then involves receiving a response to the synchronization invitation (steps 1806-1814). The process further involves recording and presenting the program (steps 1816-1822).

A user device receives via communication network 414 a synchronization invitation from another user device at another location (step 1802). The synchronization invitation includes information relating to a program scheduled for synchronized viewing. The synchronization invitation may be received directly from the other user device or may be delivered through a network or from a central server. Control circuitry 304 at the user device receiving the invitation then instructs display 312 to present the invitation to the user (step 1804). For example, control circuitry 304 may instruct display 312 to present a user interface for displaying a summary of the invitation including, e.g., the program title, the other participants, and the scheduled viewing time, as described in relation to FIG. 10A and FIG. 10B.

Control circuitry 304 may also receive via user input interface 310 a user's response to the invitation as described in relation to FIG. 10A and FIG. 10B. In this case, control circuitry 304 receives information indicating whether the user has confirmed participation in synchronized viewing (decision 1806). If control circuitry 304 receives an indication via user input interface 310 that the user has declined the invitation, control circuitry 304 cancels the scheduled synchronization (step 1808) and may send a notification via communications network 414 to the inviting user device and in some embodiments to the other invited user devices. In some embodiments, control circuitry 304 can allow the user to defer making a decision right away as to whether he will participate in the synchronized viewing. In such embodiments, control circuitry 304 may add the synchronized viewing to a schedule of synchronized viewing, although control circuitry 304 may denote that the response was deferred and that the user has not yet committed to the synchronized viewing.

If the user has accepted the invitation, control circuitry 304 determines whether the user wishes to change any features of the synchronized viewing, e.g., the program to be viewed, the other participants, whether a reminder will be given, or the scheduled frequency (step 1810). In the user interfaces shown in FIG. 10A and FIG. 10B, control circuitry 304 and user input interface 310 may allow a user to accept the invitation as received by selecting button 1006, accept the invitation as received and set a reminder by selecting button 1008, or accept the invitation upon adjusting the synchronization settings by selecting button 1012. In the case that control circuitry 304 receives via user input interface 310 user input indicating that the user wishes to adjust the settings, control circuitry 304 provides via display 312 a user interface similar to the interfaces shown in FIG. 9 or FIG. 6 from which the user can make the desired changes with user input interface 310 (step 1812). Once control circuitry 304 has received via user input interface 310 user adjustments to the synchronization or has received input that the user does not wish to adjust the synchronization settings, control circuitry 304 may request that the user confirm the settings (1814). If the user has adjusted the synchronization settings, control circuitry 304 causes the user device to send via communications network 414 the changes to the other participants, who may accept the revised synchronization settings, reject the revised synchronization settings, further adjust the synchronization settings, or decline to participate in the revised synchronization.

Once the settings have been confirmed, control circuitry 304 determines whether it is running on user equipment that is in the location in which the program becomes available the latest of all the participating locations (decision 1818). This step may be similar to decision 1618 described in relation to FIG. 16. Control circuitry 304 may record in storage 308 the program when it becomes available (step 1820) and participates in synchronized viewing when all of the participating user devices can access the program (steps 1822 and 1818). The methods for program synchronization may be similar to the methods for program synchronization described above in relation to FIG. 16.

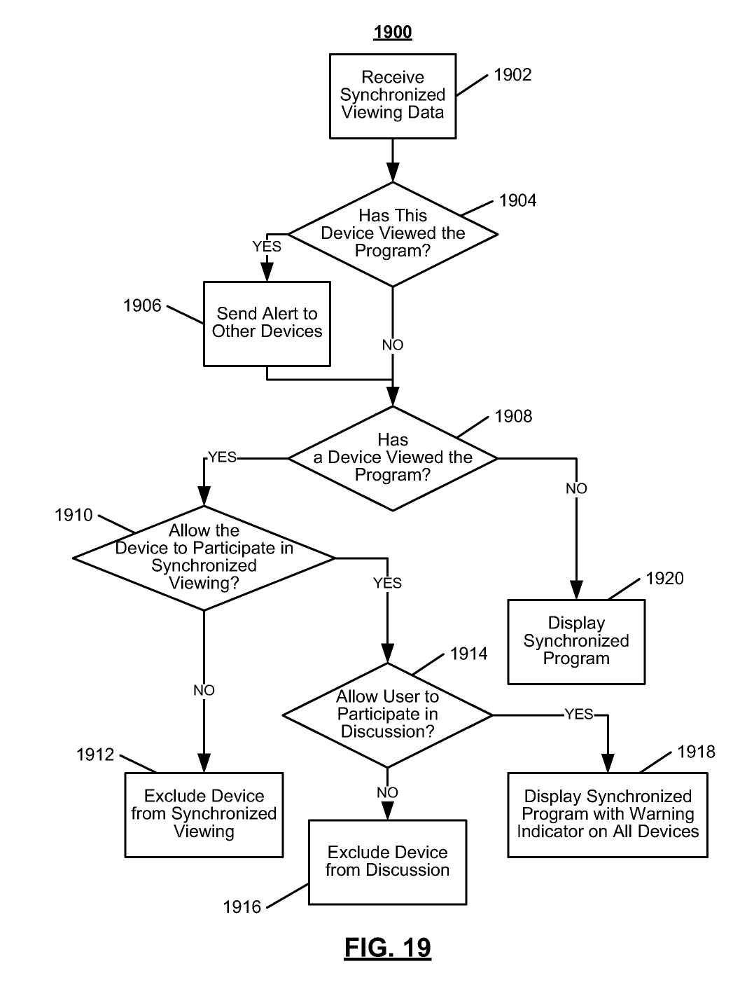

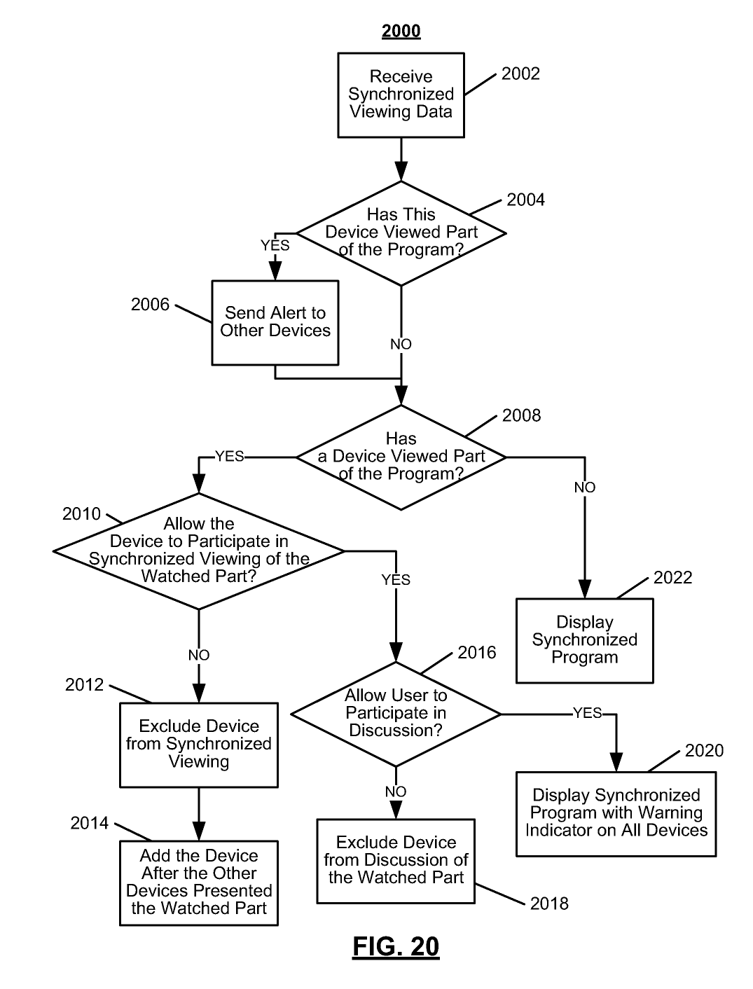

FIG. 19 shows an illustrative process 1900 for addressing a situation in which a user device scheduled for synchronized viewing of a program has viewed the program ahead of schedule. The process includes receiving via communication network 414 data related to a scheduled synchronized viewing of a program (step 1902). The process then involves determining whether the device has displayed the program and, if so, sending an alert to other devices (steps 1904 and 1906). The process may further include addressing a situation in which one of the devices scheduled to participate in synchronized viewing has viewed the program (steps 1908-1916).

Control circuitry 304 in a user device receives via communications network 414 data related to a scheduled synchronized viewing of a program (step 1902). The data may be received either from a user interacting with the user device, as described in relation to steps 1602-1612 of FIG. 16, or through an invitation from another user device in another location, as described in relation to step 1902 of FIG. 19. Control circuitry 304 monitors the programs being viewed on the device to determine whether the device is displaying or has already displayed the program scheduled for synchronized viewing before the scheduled time for synchronized viewing (step 1904). As described above in relation to FIG. 12, it is undesirable for a participant in synchronized viewing to have viewed the program before the other participants, as this may, for example, allow the viewer to cheat on a game show or spoil the plot of a drama or the result of a sports event. Thus, if control circuitry 304 determines that the viewer has viewed the program ahead of the scheduled time, control circuitry 304 automatically sends an alert via communications network 414 to the other devices scheduled to participate in synchronized viewing (step 1906). In some embodiments, this information is registered or stored at a central database for retrieval by the other user device. A user device may able to determine whether another user device has viewed a program without the other user device transmitting an alert, e.g., by querying the other user device or querying a media content source 416.

If control circuitry 304 determines that no participants have viewed the program ahead of schedule, the program is simultaneously presented (step 1920), as described above in relation to FIGS. 16 and 17. If control circuitry 304 determines that a participant has viewed the program ahead of schedule, a variety of actions could be taken, and the particular action may be dictated by guidelines. The guidelines for what action to take if the program was viewed may be established by the user who created the invitation, established by the synchronization master, determined based on a vote, or determined based on other means. Exemplary guidelines are described below in relation to steps 1910-1918.

First, control circuitry 304 on the user device that has displayed the program before the scheduled time determines if the guidelines in place for the scheduled program still permit the user to participate in the synchronized viewing (decision 1910). If the established guidelines dictate that the user may not participate, control circuitry 304 prevents the user device from participating so that the user is excluded (step 1912).

Next, if the guidelines dictate that the user is still permitted to participate in the synchronized viewing, control circuitry 304 on the user device that has displayed the program ahead of schedule determines whether it should allow the user to participate in a discussion, such as the text or video chatting described above in relation to FIGS. 14 and 15 (decision 1914). If the user is allowed to participate in the discussion, control circuitry 304 on other participating user devices may display a warning on display 312, such as the warning shown in and described in relation to FIG. 13 (step 1918). If the user is not permitted to participate in the discussion, control circuitry 304 on the user device that has displayed the program ahead of schedule may cause display 312 to present the program and the discussion of the other participants, but exclude the user from participating in the discussion (step 1916).

In some embodiments, these actions are carried out not by control circuitry 304 on the user device that presented the program ahead of schedule, but rather, is carried out by a central server, a synchronization master, or another device inaccessible to the user. This would prevent the user from tampering with control circuitry 304 or the software running on control circuitry 304 such that it the user is still able to participate in the synchronized viewing and/or the discussion.

In some embodiments, the actions to take if the program was already viewed may be based on which participant has viewed the program. For example, if one participant is known to be a cheater or a blabbermouth, the participant may be excluded from synchronized viewing. On the other hand, if another participant has a poor memory or can be trusted not to spoil the program, that participant may be allowed to engage in synchronized viewing. In some embodiments, a predetermined course of may be overridden if the other participants believe that a viewer has in fact not viewed the program but was, for example, viewed by another member of the participant's household.

FIG. 20 shows an illustrative process 2000 for addressing a situation in which a device scheduled for synchronized viewing of a program has viewed a part the program ahead of schedule. The process includes receiving data related to a scheduled synchronized viewing of a program (step 2002). The process then involves determining whether the device has displayed a part of the program and, if so, sending an alert to other devices (steps 2004 and 2006). The process may further include addressing a situation in which one of the devices scheduled to participate in synchronized viewing has viewed a part the program (steps 2008-2020).

The steps of process 2000 are similar to the steps of process 1900 and may be carried out in a similar manner. However, in process 2000, it is determined whether a user device has displayed only a part or segment of the program, rather than the entire program (decision 2004). In this case, control circuitry 304 and/or the central server may take any of the actions described above with respect to process 1900. However, once the other participants have viewed the part that was presented ahead of schedule, the user device that had presented the program ahead of schedule may be permitted to participate in synchronized viewing. In this case, control circuitry 304 may automatically begin synchronized viewing once the user is permitted to participate, or the user may request to be added to the synchronized viewing.

If user device has displayed a middle segment or an end segment of a program rather than a beginning segment, control circuitry 304 may or may not allow the user to participate in synchronized viewing of the part of the program up to the segment that the user device has already been presented.

It should be understood that the above steps of the flow diagrams of FIGS. 16-20 may be executed or performed in any order or sequence not limited to the order and sequence shown and described in the figures. Also, some of the above steps of the flow diagrams of FIGS. 16-20 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for synchronizing simultaneous media asset viewing with different user devices, the method comprising:
identifying a group of devices selected for simultaneous viewing of a media asset;
determining, by control circuitry at a media source, for each user device in the group of user devices, a latency between the media source and the respective user device, wherein the determined latency comprises a transmission latency corresponding to a transmission time between the media source and the user device; and
adjusting, by communications circuitry at the media source, delivery of the media asset from the media source to each of the user devices in the group based on the determined latency between the media source and each of the user devices in the group.

2. The method of claim 1, wherein the media source is one of the user devices in the group that accesses the media asset from storage.

3. The method of claim 2, wherein the media source displays the media asset based on the determined latencies between the media source and each of the user devices in the group.

4. The method of claim 1, wherein the media source is a media content source of a media content provider.

5. The method of claim 1, further comprising receiving, by communications circuitry at a first user device in the group of user devices, a request from a second user device in the group of user devices to synchronize viewing of the media asset with the group of user devices.

6. The method of claim 5, wherein the synchronized viewing of the media asset begins at a predetermined time period after the second user device transmits the synchronization request.

7. The method of claim 1, further comprising:
determining, by control circuitry, a delay for transmitting the program to each user device in the group of user devices, wherein the determined delay for each user device in the group of user devices is based on the difference between the latency of the user device and the highest latency determined for the group of user devices; and
transmitting, by the communications circuitry at the media source, the media asset from the media source to each of the user devices based on the determined delays.

8. The method of claim 1, wherein the latencies between the media source and each of the user devices in the group of user devices further comprises a decoding time of the user device, the method further comprising determining, by the control circuitry, the decoding time of the user device.

9. The method of claim 1, wherein each user device in the group of user devices adjusts the display of the media asset based on the latencies for the group of user devices.

10. The method of claim 1, wherein by participating in synchronized viewing, at least one user device in the group of user devices accesses the media asset before the media asset is aired in a geographic region of the at least user device.

11. A system for synchronizing simultaneous media asset viewing with different user devices, the system comprising:
control circuitry at a media source configured to:
identify a group of devices selected for simultaneous viewing of a media asset; and
determine, for each user device in the group of user devices, a latency between the media source and the respective user device, wherein the determined latency comprises a transmission latency corresponding to a transmission time between the media source and the user device; and
communications circuitry at the media source configured to adjust delivery of the media asset from the media source to each of the user devices in the group based on the determined latency between the media source and each of the user devices in the group.

12. The system of claim 11, wherein the media source is one of the user devices in the group that accesses the media asset from storage.

13. The system of claim 12, wherein the control circuitry is further configured to display the media asset based on the determined latencies between the media source and each of the user devices in the group.

14. The system of claim 11, wherein the media source is a media content source of a media content provider.

15. The system of claim 11, further comprising communications circuitry at a first user device in the group of user devices configured to receive a request from a second user device in the group of user devices to synchronize viewing of the media asset with the group of user devices.

16. The system of claim 15, wherein the synchronized viewing of the media asset begins at a predetermined time period after the second user device transmits the synchronization request.

17. The system of claim 11, wherein the control circuitry is further configured to determine a delay for transmitting the program to each user device in the group of user devices, wherein the determined delay for each user device in the group of user devices is based on the difference between the latency of the user device and the highest latency determined for the group of user devices; and the communications circuitry is further configured to transmit the media asset from the media source to each of the user devices based on the determined delays.

18. The system of claim 11, wherein the latencies between the media source and each of the user devices in the group of user devices further comprises a decoding time of the user device, the control circuitry is further configured to determine the decoding time of the user device.

19. The system of claim 11, wherein each user device in the group of user devices adjusts the display of the media asset based on the latencies for the group of user devices.

20. The system of claim 11, wherein by participating in synchronized viewing, at least one user device in the group of user devices accesses the media asset before the media asset is aired in a geographic region of the at least user device.

21-30. (canceled)
